(19) United States
(12) Patent Application Publication
(10) Pub. No.: US 2004/0126241 A1
(43) Pub. Date: Jul. 1, 2004

(54) Forward swept high efficiency airplane propeller blades

(76) Inventors: Gecheng Zha, Coral Gables, FL (US); Craig Paxton, Miami, FL (US); Peter Gryn, Miramar, FL (US); Ulises Perez, Miami, FL (US); Erisa Hines, Wheaton, MO (US)

Correspondence Address: Gecheng Zha, Dept. of Mechanical Engineering, University of Miami, Coral Gables, FL, 33124, US

(21) Appl. No.: 10/330,225

(22) Filed: Dec. 30, 2002

(51) Int. Cl. F03B 3/12

(52) U.S. Cl. 416/223 R

(57) ABSTRACT

A high efficiency forward swept airplane propeller includes a constant leading edge forward swept angle from the root to the tip. The forward sweep is created by leaning the blade leading edge tangentially toward the rotating direction on the rotating plane. The leading edge projection on the axial-radial plane is a straight line with constant axial position from the blade root to the tip. Alternate embodiments of the projection of the leading edge on the tangential rotating plane include: a propeller blade with a leading edge shape that has a smaller forward sweep angle (including 0 degree) in the inner portion of the blade and a larger forward sweep angle in the outer portion; a propeller blade that has a negative leading edge aft ward sweep angle in the inner portion of the blade and a positive forward sweep angle in the outer portion. Alternate embodiment of the leading edge shape projection on the axial-radial plane include a shape which is not a constant line, but at any radial position, the maximum leading edge axial deviation from the root axial position is less than the blade airfoil chord length at that radial position. Compared to the radial blade or backward swept blade, the mechanism that causes the forward swept blade to have a better performance is that the tip pulls more mass flow and has higher flow kinetic energy in the tip region, which suppresses the tip vortex. The effective aspect ratio of the blade is larger and the induced drag and downwash are smaller. The wind tunnel tests and the simulations using 3D computational fluid dynamics software indicated that the forward swept propeller blade of this invention significantly improves the efficiency and stall margin compared to the conventional radial blade.

### 1. BACKGROUND OF THE INVENTION

1.1 Technical Field of Invention

The present invention relates generally to an airplane propeller blade and more particularly to a forward swept, high efficiency airplane propeller blade.

1.2 Discussion of the Related Art

The vast majority of general aviation aircraft in the world are powered by propeller engines, which include subsonic military and civil transports, agriculture and emergency rescuer airplanes, private airplanes, and model airplanes, etc. The improvement of propeller performance will have tremendous impact on reducing airplane fuel consumption and noise level.

After War World II, the aerodynamic design of an aft swept wing has achieved great success and is widely used for the modem high subsonic, transonic and supersonic airplanes. In 1940-50's, the aft ward swept technology was applied to airplane propeller blade design. In late 1970's to 1980's, interests were revived to conduct advanced propeller design under the background of world oil crisis. NASA made a series of designs and tests to implement propeller design with aft ward aerodynamic sweep. Significant improvement in efficiency and noise reduction were achieved at high subsonic Mach number. Even with the progress of the aerodynamic sweep technology, the majority of the propeller blades used today are radial blades with no aerodynamic sweep.

Compared to the radial blade or aft swept blade, the mechanism that causes the forward swept blade to have a better performance is that the tip touches the “clean air” first, pulls more mass flow and has higher flow kinetic energy in the tip region, which suppresses the tip vortex. The effective aspect ratio of the forward swept blade is larger and the induced drag and downwash are smaller. The blade therefore can achieve higher efficiency and wider operability range (stall margin). The turbulence intensity due to the tip vortex is lower and therefore less noise is generated.

It is accordingly an object of the present invention to provide an airplane propeller to improve efficiency.

It is a further object of the present invention to provide a airplane propeller to increase propeller stall margin and operability range.

It is a further object of the present invention to provide a airplane propeller to reduce the noise.

### 2. SUMMARY OF THE INVENTION

An airplane propeller blade is described which includes a constant leading edge forward swept angle from the root to the tip. The forward sweep is created by leaning the blade leading edge tangentially toward the rotating direction. The value of the constant leading edge forward sweep angle varies between about 10 degree and 50 degree, and the preferred value lies between 20 degree and 30 degree.

Alternate embodiments of the leading edge shape projection on the tangential plane include: a blade that has a small positive leading edge forward sweep angle in the inner portion of the blade and a larger positive leading edge forward sweep angle in the outer portion. The inner portion forward sweep angle is either a constant or varies monotonically and the value is between 0 degree and about 40 degree, preferably between 5 and 10 degree, the outer portion leading edge forward sweep angle is either a constant or varies monotonically, and the value is 0 to 20 degree greater than the maximum forward sweep angle of the inner portion of the blade leading edge. The preferred outer portion forward sweep angle is 15 degree to 30 degree; a propeller blade that has a negative aft ward sweep angle in the inner portion and a positive forward sweep in the outer portion. The inner portion negative sweep angle is either a constant or varies monotonically and the value is between −5 degree and −40 degree, preferably between −10 and −20 degree, the outer portion leading edge forward sweep angle is either a constant or varies monotonically and the value is between 5 and 40 degree, preferably between 15 degree to 30 degree.

The preferred leading edge shape projection on the axial-radial plane (side view) is a straight line with constant axial location from the blade root to the tip. At a particular radial position, the leading edge shape projection on the axial-radial plane is allowed to deviate from the constant position determined by the root, but the maximum deviation from the root axial location is less than the blade airfoil chord length at that radial position.

Compared to the radial blade or backward swept blade, the mechanism that causes the forward swept blade to have a better performance is that the tip pulls more mass flow and has higher flow kinetic energy in the tip region, which suppresses the tip vortex. The effective aspect ratio of the blade is larger and the induced drag and downwash are smaller. The blade therefore can achieve higher efficiency and wider operability range (stall margin). The wind tunnel tests and the simulations using 3D computational fluid dynamics software indicated that the forward swept propeller blade of this invention significantly improves the efficiency and stall margin compared to the straight conventional radial blade.

### 3. BRIEF DESCRIPTION OF THE DRAWING

FIG. 1 is a front view of the 3-dimensional propeller blade with constant forward sweep angle. The front view is the projection of the leading edge on the tangential rotating plane.

FIG. 2 is a side view of the 3-dimensional propeller blade with a constant leading edge axial position from the root to the tip. The side view is the projection of the leading edge on the axial-radial plane.

FIG. 3 is the front view of the leading edge shape of a propeller blade with a constant forward sweep angle.

FIG. 4 is the front view of the leading edge shape of a propeller blade with a smaller forward sweep angle in the inner portion of the blade and a larger forward sweep angle in the outer portion of the blade.

FIG. 5 is the front view of the leading edge shape of a propeller blade with a zero forward sweep angle in the inner portion of the blade and a positive forward sweep angle in the outer portion of the blade.

FIG. 6 is the front view of the leading edge shape of a propeller blade with a aft ward (negative) sweep angle in the inner portion of the blade and a forward (positive) sweep angle in the outer portion of the blade.

### 4. DETAILED DESCRIPTION OF THE INVENTION

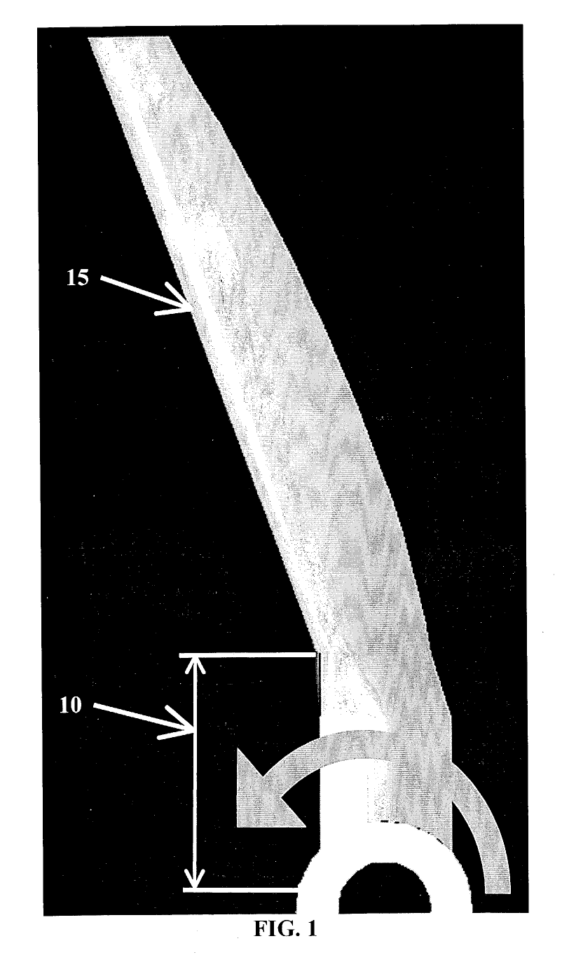

FIG. 1 shows a propeller with leading edge 15 leaning toward the propeller rotating direction (the rotating direction in FIG. 1 is counter clockwise), which creates the effect of the forward sweep. The size of the hub 10 is determined by the specific engine installation and is not a part of the forward sweep propeller blade.

FIG. 1 is the front view of the propeller blades. That is to view the blade in front of the blade (upwind wind position) along the axis of the rotation. FIG. 1 is hence the projection of the leading edge on the tangential rotating plane.

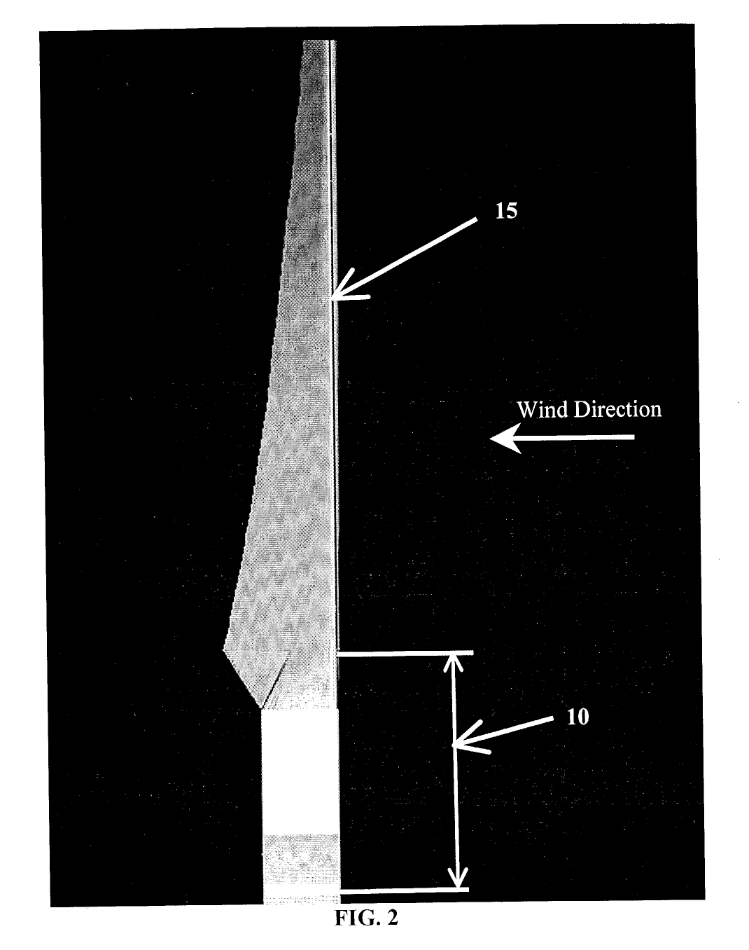

To determine the 3-dimensional shape of the leading edge, the projection of the leading edge on the axial-radial plane also needs to be determined. FIG. 2 shows the side view of the leading edge 15 shape of the present invention, which is a straight line 15 with constant axial location from the root to the tip 15. The side view is to view the blade in the direction normal to the coming wind and is the leading edge projection on the axial-radial plane. The axial direction is the same as the wind direction (see FIG. 2).

The forward sweep effect of the present invention is primarily obtained from the tangential lean of the blade leading edge toward the rotating direction as shown in FIG. 1. There is no sweep in axial direction. The advantage of achieving the sweep by tangential lean is that it saves axial space. However, a small variation of the leading edge axial location will not greatly affect the forward swept effect of the present invention.

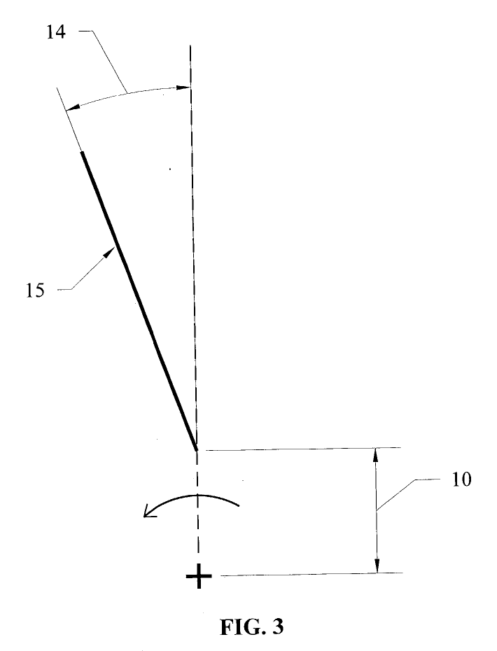

The amount and shape of the forward sweep is controlled by the leading edge 15 sweep angle 14 between the radial line and the leading edge (see FIG. 3). The sign of the sweep angle is defined as positive if the leading edge of the blade is leaned toward the rotating direction 14, negative if it is leaned toward the opposite direction of the rotation. The rotating direction can be either clockwise or counterclockwise.

The necessary condition to create the forward sweep in this invention is that the blade must have a positive sweep angle in the outer portion of the blade 14 (see FIG. 3). In other words, the leading edge of the blade in the tip region must lean toward the rotating direction no matter the rotating direction is clockwise or counterclockwise.

The preferred leading edge shape projection on the rotating plane and axial-radial plane are those shown in FIG. 1 and FIG. 2, which creates leading edge forward sweep with a constant sweep angle for the whole blade. The preferred value of the constant forward sweep angle 14 (see FIG. 3) is about 20 degree to 30 degree from the root to the tip (the blade root is defined as the top of the hub 10 (see FIG. 1, FIG. 3)).

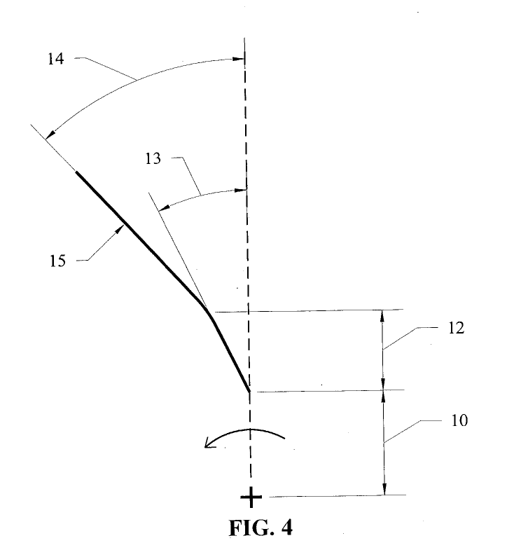

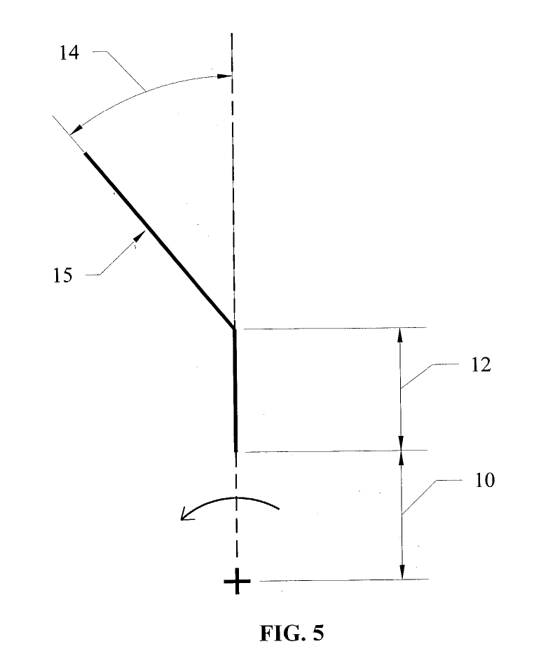

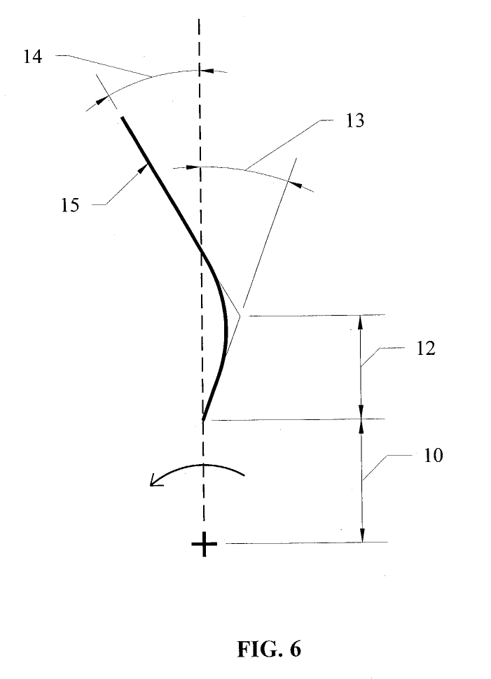

Alternate embodiments of the leading edge shape projection on the tangential plane include: a propeller blade with a leading edge shape 15 that has a smaller positive leading edge forward sweep angle about 5 to 10 degree in the inner portion 13 and a larger positive leading edge forward sweep angle about 15 to 30 degree in the outer portion 14 (see FIG. 4); a propeller blade with a leading edge shape 15 that has a zero leading edge forward sweep angle in the inner part of the blade and positive leading edge forward sweep angle about 15 to 30 degree in the outer portion 14 (see FIG. 5); a propeller blade with a leading edge shape 15 that has a negative leading edge backward sweep angle about −10 to −20 degree in the inner portion of the blade 13 and a positive leading edge forward sweep angle about 15 to 30 degree in the outer portion 14 (see FIG. 6).

Alternate embodiment of the leading edge shape projection on the axial-radial plane include a shape that is not a constant axial position line, but at any radial position, the maximum leading edge axial deviation from the root axial position is less than the blade airfoil chord length at that radial position.

For a blade with a non-uniform forward sweep angel as shown in FIG. 4 to FIG. 6, the preferred radial location for the sweep angle to transit from the inner portion to the outer portion 12 is at 30% to 50% of the total blade span length location measured from the root. The blade span length is defined as the length of the blade from the root to tip.

The wind tunnel tests and the simulations using 3D computational fluid dynamics software indicated that the forward swept propeller blade of this invention significantly improves the efficiency and stall margin compared to the straight conventional radial blade.

Compared to the radial blade or backward swept blade, the mechanism that causes the forward swept blade to have a better performance is that the tip touches the “clean air” first, pulls more mass flow and has higher flow kinetic energy in the tip region, which suppresses the tip vortex. The effective aspect ratio of the blade is also larger. Hence the induced drag and downwash are smaller. The blade therefore can achieve higher efficiency and wider operability range (stall margin). The turbulence intensity due to the tip vortex is lower and therefore less noise is expected to be generated.

Even though our invention has been illustrated and described with reference to the preferred and alternate embodiments thereof, we wish to have it understood that it is in no way limited to the details of such embodiments, but is capable of numerous modifications for many mechanisms, and is capable of numerous modifications within the scope of the appended claims.

We claim:

1. An airplane propeller blade, comprising:
a leading edge leaned toward the rotating direction at a constant forward (positive) sweep angle from the blade root to the tip.

2. The airplane propeller blade according to claim 1, wherein the value of the constant leading edge forward sweep angle measured on the rotating plane varies between about 10 degree and 50 degree.

3. The airplane propeller blade according to claim 1, wherein the leading edge of the blade has a constant axial position (coordinate) at any radial location of the blade from the root to the tip.

4. The airplane propeller blade according to claim 1, wherein, at any radial position of the blade leading edge, the axial location varies, but does not deviate from the root axial location by more than the blade airfoil chord length at that radial position.

5. An airplane propeller blade, comprising:
a leading edge leaned toward the rotating direction with smaller forward (positive) sweep angle in the inner portion of the blade and larger forward (positive) sweep angle in the outer portion of the blade.

6. The airplane propeller blade according to claim 5, wherein the inner portion leading edge forward sweep angle measured on the rotating plane is either a constant or varies monotonically and the value is between 0 degree and about 40 degree. The outer portion leading edge forward sweep angle measured on the rotating plane is either a constant or varies monotonically and the value is 0 to 20 degree greater than the maximum forward sweep angle of the inner portion of the blade leading edge.

7. The airplane propeller blade according to claim 5, wherein the leading edge of the blade has a constant axial position (coordinate) at any radial location of the blade from the root to the tip.

8. The airplane propeller blade according to claim 5, wherein, at any radial position of the blade leading edge, the axial location varies, but does not deviate from the root axial location by more than the blade airfoil chord length at that radial position.

9. The airplane propeller blade according to claim 5, wherein the transition from the inner portion of the leading edge to the outer portion of the leading edge occurs at about 20% to 80% of the total blade span length location measured from the root.

10. An airplane propeller blade, comprising:
the inner portion of the blade leading edge leaned toward the opposite rotating direction with aft ward (negative) sweep angle and the outer portion of the blade leaned toward the rotating direction with forward (positive) sweep angle.

11. The airplane propeller blade according to claim 10, wherein the inner portion leading edge aft ward sweep angle measured on the rotating plane is either a constant or varies monotonically and the value is between about −5 degree and 40 degree, the outer portion leading edge forward sweep angle measured on the rotating plane is either a constant or varies monotonically and the value is between about 5 and 40 degree.

12. The airplane propeller blade according to claim 10, wherein the leading edge of the blade has a constant axial position (coordinate) at any radial location of the blade from the root to the tip.

13. The airplane propeller blade according to claim 10, wherein, at any radial position of the blade leading edge, the axial location varies, but does not deviate from the root axial location by more than the blade airfoil chord length at that radial position.

14. The airplane propeller blade according to claim 10, wherein the transition from the inner portion of the leading edge to the outer portion of the leading edge occurs at about 20% to 80% of the total blade span length location measured from the root.
